(19) United States
(12) Patent Application Publication
(10) Pub. No.: US 2013/0047581 A1
(43) Pub. Date: Feb. 28, 2013

(54) Reagent Dosing System

(71) Applicant: Joseph G. Ralph, Owosso, MI (US)

(72) Inventor: Joseph G. Ralph, Owosso, MI (US)

(21) Appl. No.: 13/216,473

(22) Filed: Aug. 24, 2011

(51) Int. Cl. F01N 3/18; B01D 53/92

(52) U.S. Cl. 60/274; 423/212

(57) ABSTRACT

A method of injecting a reagent into a stream of exhaust output from an engine to change the composition of the exhaust includes obtaining a target reagent injection rate. A calculation period is set to a time greater than one second. The target injection rate is multiplied by the time of the calculation period to determine an amount of reagent to be injected during the calculation period. An injection duty cycle is set. An injection duration is determined to inject the determined amount of reagent based on the injection duty cycle. The reagent is injected at the duty cycle for the injection duration.

### FIELD

The present disclosure relates to exhaust gas treatment systems. More particularly, a reagent injection control system is provided to expand the range of injection rates available from a single injector and reduce the proliferation of differently sized injectors.

### BACKGROUND

This section provides background information related to the present disclosure which is not necessarily prior art.

To reduce the quantity of undesirable particulate matter and NOₓ emitted to the atmosphere during internal combustion engine operation, a number of exhaust aftertreatment systems have been developed. The need for exhaust aftertreatment systems particularly arises when diesel combustion processes are implemented.

One method used to reduce NOₓ emissions from internal combustion engines is known as selective catalytic reduction (SCR). SCR may include injecting a reagent into the exhaust stream of the engine to form a reagent and exhaust gas mixture that is subsequently passed through a reactor containing a catalyst, such as, activated carbon, or metals, such as platinum, vanadium, or tungsten, which are capable of reducing the NOₓ concentration in the presence of the reagent.

An aqueous urea solution is known to be an effective reagent in SCR systems for diesel engines. However, use of an aqueous solution and other reagents may include disadvantages. Urea is highly corrosive and attacks mechanical components of the SCR system. Urea also tends to solidify upon prolonged exposure to high temperatures, such as encountered in diesel exhaust systems. A concern exists because the reagent that creates a deposit is not used to reduce the NOₓ.

Urea injection systems for the treatment of diesel engine exhaust vary substantially in that different original equipment manufacturers (OEMs) specify reagent injectors having different ranges of injection flow rates. When reviewing several different OEM specifications together, the entire range of reagent injection flow rates to be provided may be expansive. As such, manufacturers of reagent injectors presently provide several different injectors each having a similar total flow rate range but sized such that the maximum and minimum values are spaced apart from one another. Unfortunately, provision of many different injectors increases costs due to product proliferation. Furthermore, some applications may fall between existing injection flow rate ranges thereby requiring yet another injector to be designed.

The need for several different injectors is based on the fact that each injector includes a mechanism for opening and closing the valve to initiate and discontinue the flow of reagent therefrom. These systems are mechanical in nature and require a minimum amount of time to move between a fully open valve position and a fully closed valve position. The minimum time associated with this mechanical operation may be approximately 0.050 seconds. Accordingly, even when a reagent injector is controlled using pulse width modulation, a minimum operating duty cycle of approximately five percent may be the lowest attainable based on the mechanical response characteristics of the injector. Accordingly, it may be advantageous to provide methods for injecting a reagent into the exhaust stream of an internal combustion engine to minimize reagent injector proliferation and improve the control of injecting reagent within the exhaust gas.

### SUMMARY

This section provides a general summary of the disclosure, and is not a comprehensive disclosure of its full scope or all of its features.

A method of injecting a reagent into a stream of exhaust output from an engine to change the composition of the exhaust includes obtaining a target reagent injection rate. A calculation period is set to a time greater than one second. The target injection rate is multiplied by the time of the calculation period to determine an amount of reagent to be injected during the calculation period. An injection duty cycle is set. An injection duration is determined to inject the determined amount of reagent based on the injection duty cycle. The reagent is injected at the duty cycle for the injection duration.

A method of injecting a reagent into a stream of exhaust output from an engine to change the composition of the exhaust includes determining a quantity of reagent to be injected based on a vehicle operating parameter. The method also includes determining a target reagent injection rate and injecting reagent into the exhaust stream with a burst dosing control based on the target injection rate being less than a minimum injection rate of the injector. The burst dosing includes setting a period for calculations to a time greater than one second, multiplying the target injection rate by the time of the set period to determine an amount of reagent to be injected during the period, determining an injection duration to inject the determined amount of reagent based on a predetermined injection duty cycle, and injecting reagent at the predetermined duty cycle for the injection duration.

A method of injecting a reagent into a stream of exhaust output from an engine to change the composition of the exhaust includes obtaining a target reagent injection rate. A calculation period is set to a time greater than one second. The target injection rate is multiplied by the time of the calculation period to determine an amount of reagent to be injected during the calculation period. An injection duration is set equal to the calculation period. An injection duty cycle is determined to inject the determined amount of reagent in equal increments over the injection duration. Reagent is injected at the duty cycle for the injection duration.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 provides a schematic diagram of an exemplary internal combustion engine with an emissions control system equipped with a reagent dosing system;

FIG. 2 is graphical depiction of injector flow rates provided from two different injectors;

FIG. 3 is a flow chart relating to a method of controlling a reagent injector; and

FIG. 4 is another flow chart relating to reagent injection control.

Corresponding reference numerals indicate corresponding parts throughout the several views of the drawings.

### DETAILED DESCRIPTION

Example embodiments will now be described more fully with reference to the accompanying drawings.

It should be understood that although the present teachings may be described in connection with diesel engines and the reduction of NOₓ emissions, the present teachings can be used in connection with any one of a number of exhaust streams, such as, by way of non-limiting example, those from diesel, gasoline, turbine, fuel cell, jet or any other power source outputting a discharge stream. Moreover, the present teachings may be used in connection with the reduction of any one of a number of undesired emissions. For example, injection of hydrocarbons for the regeneration of diesel particulate filters is also within the scope of the present disclosure. For additional description, attention should be directed to commonly-assigned U.S. Patent Application Publication No. 2009/0179087A1, filed Nov. 21, 2008, entitled “Method And Apparatus For Injecting Atomized Fluids”, which is incorporated herein by reference.

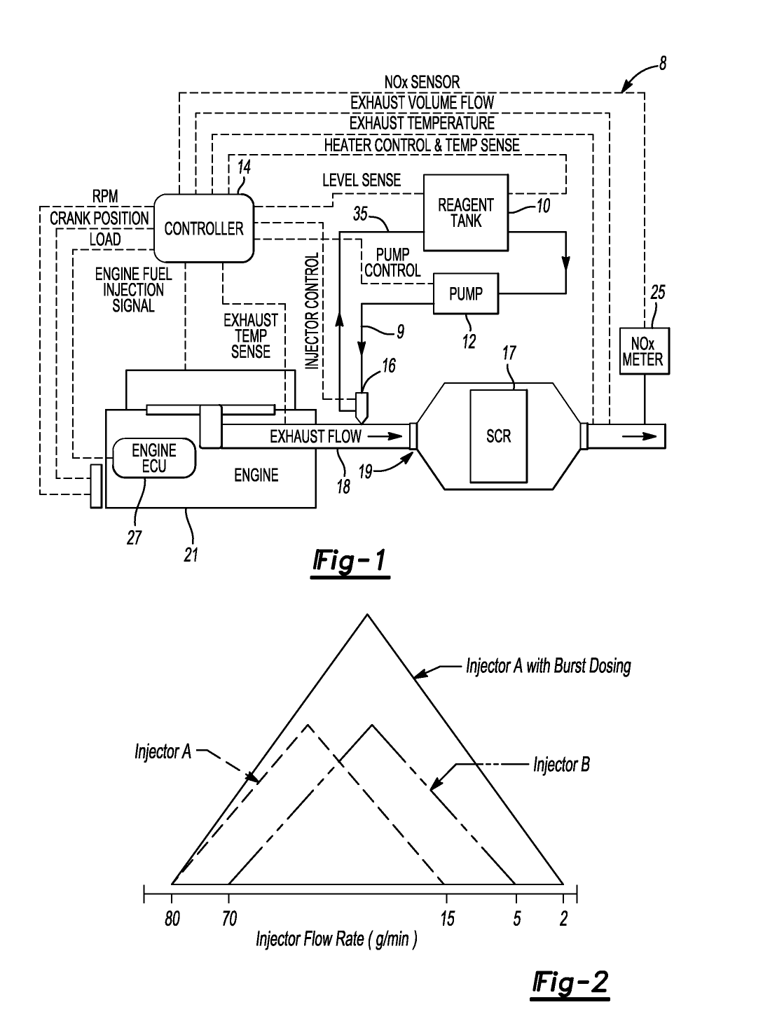

With reference to the Figures, a pollution control system 8 for reducing NOₓ emissions from the exhaust of a diesel engine 21 is provided. In FIG. 1, solid lines between the elements of the system denote fluid lines for reagent and dashed lines denote electrical connections. The system of the present teachings may include a reagent tank 10 for holding the reagent and a delivery module 12 for delivering the reagent from the tank 10. The reagent may be a urea solution, a hydrocarbon, an alkyl ester, alcohol, an organic compound, water, or the like and can be a blend or combination thereof. It should also be appreciated that one or more reagents can be available in the system and can be used singly or in combination. The tank 10 and delivery module 12 may form an integrated reagent tank/delivery module. Also provided as part of system 8 is an electronic injection controller 14, a reagent injector 16, and an exhaust system 19. Exhaust system 19 includes an exhaust conduit 18 providing an exhaust stream to at least one catalyst bed 17.

The delivery module 12 may comprise a pump that supplies reagent from the tank 10 via a supply line 9. The reagent tank 10 may be polypropylene, epoxy coated carbon steel, PVC, or stainless steel and sized according to the application (e.g., vehicle size, intended use of the vehicle, and the like). A pressure regulator (not shown) may be provided to maintain the system at predetermined pressure setpoint (e.g., relatively low pressures of approximately 60-80 psi, or in some embodiments a pressure of approximately 60-150 psi) and may be located in the return line 35 from the reagent injector 16. A pressure sensor may be provided in the supply line 9 leading to the reagent injector 16. The system may also incorporate various freeze protection strategies to thaw frozen reagent or to prevent the reagent from freezing. During system operation, regardless of whether or not the injector is releasing reagent into the exhaust gases, reagent may be circulated continuously between the tank 10 and the reagent injector 16 to cool the injector and minimize the dwell time of the reagent in the injector so that the reagent remains cool. Continuous reagent circulation may be necessary for temperature-sensitive reagents, such as aqueous urea, which tend to solidify upon exposure to elevated temperatures of 300° C. to 650° C. as would be experienced in an engine exhaust system.

Furthermore, it may be desirable to keep the reagent mixture below 140° C. and preferably in a lower operating range between 5° C. and 95° C. to ensure that solidification of the reagent is prevented. Solidified reagent, if allowed to form, may foul the moving parts and openings of the injector.

The amount of reagent required may vary with load, engine speed, exhaust gas temperature, exhaust gas flow, engine fuel injection timing, desired NOₓ reduction, barometric pressure, relative humidity, EGR rate and engine coolant temperature. A NOₓ sensor or meter 25 is positioned downstream from catalyst bed 17. NOₓ sensor 25 is operable to output a signal indicative of the exhaust NOₓ content to an engine control unit 27. All or some of the engine operating parameters may be supplied from engine control unit 27 via the engine/vehicle databus to the reagent electronic injection controller 14. The reagent electronic injection controller 14 could also be included as part of the engine control unit 27. Exhaust gas temperature, exhaust gas flow and exhaust back pressure and other vehicle operating parameters may be measured by respective sensors.

When commercialized, it has been determined that a single reagent injector 16 may not be operable to provide a broad enough range of reagent injection flow rates to be applicable across many exhaust treatment systems where different ranges of reagent injection flow rate are required. As previously mentioned, when several different OEM injector specifications are grouped together, the entire range of reagent injection flow rates may be expansive. For example, one OEM may request a minimum reagent flow rate of approximately 2 grams per minute while the same or another OEM may have an application for an injector capable of outputting a maximum reagent injection flow rate of 80 grams per minute. At this time, no single injector is capable of providing these flow rates under known control conditions. As such, several different injectors have been commercialized to provide subsets of the entire reagent injection flow rate range.

FIG. 2 provides exemplary injector A providing a reagent injection flow rate ranging from 15 grams per minute to 80 grams per minute. Injector B is configured to supply a reagent injection flow rate ranging from 5 grams per minute to 70 grams per minute. Both injector A and injector B have a mechanical limitation as to the maximum frequency at which injection may be controlled. The mechanisms associated with opening and closing the valve to inject a reagent require a minimum amount of time to move between a fully opened valve condition and a fully closed valve condition. This mechanical response limitation defines the minimum injection rate of the particular injector. The minimum time associated with this mechanical operation may be approximately 0.050 seconds or five percent of one second. In the example previously described in relation to FIG. 2, injector A, when operating at a five percent duty cycle, supplies a minimum of 15 grams per minute.

As previously mentioned, it may be desirable to provide a reagent injection flow rate of less than 15 grams per minute and a maximum of 80 grams per minute with the same injector. The present disclosure provides a system for utilizing injector A to provide an expanded flow rate range.

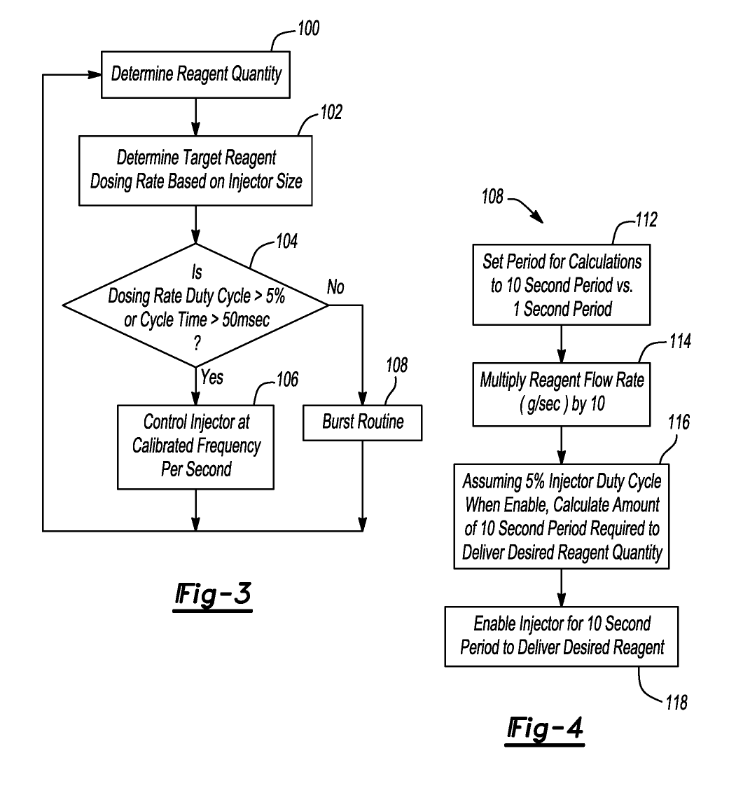

FIG. 3 presents a control scheme useful for extending the useful injection rate range of a certain size injector. The control scheme utilizes burst dosing control to overcome the mechanical response limitations of the injectors as previously discussed. Description of control begins at block 100 where a quantity of reagent to be injected is determined. As previously stated, the amount of reagent required to properly reduce undesirable emissions may vary with engine load, engine speed, exhaust gas temperature, exhaust gas flow rate, engine fuel injection timing, environmental conditions, engine operating temperature, EGR rate, and a desired amount of NOₓ reduction, among others. At block 102, control determines a target reagent dosing rate of reagent mass per second based on the quantity of reagent determined at block 100 and the output characteristics of the specific injector being controlled.

At decision block 104, control determines whether the target dosing rate requires injector 16 to cycle on and off in greater than 50 milliseconds. This time corresponds to a five percent duty cycle when injector 16 is controlled to operate at a frequency based on a number of cycles per second. If a greater than five percent duty cycle is required, control continues to block 106 where injector 16 receives a signal to operate at a suitable frequency to provide the requested duty cycle. The target reagent dosing rate may be supplied by injector 16 because the driving control frequency does not exceed the mechanical response limits of the injector.

If a cycle time less than or equal to 50 milliseconds is desired, control proceeds to block 108 to execute a burst dosing injector control routine. FIG. 4 provides a flow chart relating to burst dosing routine 108. To perform the burst dosing routine, control proceeds to block 112 where a period for reagent injection calculations is set to a ten second period instead of the typical one second period. Control continues to block 114 where the target reagent dosing rate determined in block 102 is multiplied by 10. Block 114 changes the one second time base to a ten second time base and calculates the mass of reagent that is to be injected over a ten second time frame.

At block 116, control determines an amount of time that injector 16 should be operated at a predetermined duty cycle to deliver the mass of reagent calculated at block 114. In one example, control sets a five percent injector duty cycle to deliver reagent over the ten second time frame. As such, control calculates the amount of time injector 16 must be energized at a five percent duty cycle to deliver the desired amount of reagent. At block 118, injector 16 is operated at the predetermined duty cycle for the amount of time determined at block 116 to deliver the quantity of reagent determined at block 114. It should be appreciated that the five percent duty cycle used to control injector 16 is merely exemplary and other predetermined duty cycles may be set. Alternatively, a different calculation may be made to evenly distribute the reagent over the entire ten second period. At block 116, an alternate calculation may be performed where a duty cycle is calculated to deliver the mass of reagent determined at block 114 in equal increments over the entire ten second period. Injector 16 is controlled to inject reagent for ten seconds at the calculated duty cycle.

The nature of the catalytic reaction taking place between a urea and a SCR catalyst or a hydrocarbon reagent and a suitable catalyst enables implementation of the burst dosing method. The SCR catalyst associated with urea reagent injection is capable of absorbing the reagent and temporarily storing the reagent for subsequent NOₓ reduction. As such, a burst dosing delivery may be effective even though the reagent is being injected at a higher rate than required to drive the chemical reaction when viewed on a per second time basis.

The method may also include other control steps to assure that the control condition has not changed greater than a predetermined amount during the ten second burst routine period of time. If a substantial change in the required amount of reagent occurs during a ten second control period, control may return to block 100 to restart the process.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of injecting a reagent into a stream of exhaust output from an engine to change the composition of the exhaust, the method comprising:
determining a quantity of reagent to be injected based on a vehicle operating parameter;
determining a target reagent injection rate; and
injecting reagent into the exhaust stream with a burst dosing control based on the target injection rate being less than a minimum injection rate of the injector, wherein burst dosing includes setting a period for calculations to a time greater than one second, multiplying the target injection rate by the time of the set period to determine an amount of reagent to be injected during the period, determining an injection duration to inject the determined amount of reagent based on a predetermined injection duty cycle, and injecting reagent at the predetermined duty cycle for the injection duration.

2. The method of claim 1, wherein the target reagent injection rate is based on an injector delivery parameter.

3. The method of claim 2, wherein the injector delivery parameter includes a flow rate deliverable by the injector.

4. The method of claim 1, wherein the vehicle operating parameter includes at least one of engine load, engine speed, exhaust gas temperature, and exhaust gas flow rate.

5. The method of claim 1, wherein the minimum injection rate of the injector is based on a minimum cycle response time required to start and stop reagent injection.

6. The method of claim 5, wherein the minimum injection cycle response time is substantially 0.050 seconds.

7. The method of claim 6, wherein the set period of time is substantially ten seconds.

8. The method of claim 1, wherein the predetermined injection duty cycle includes a five percent duty cycle.

9. A method of injecting a reagent into a stream of exhaust output from an engine to change the composition of the exhaust, the method comprising:
obtaining a target reagent injection rate;
setting a calculation period to a time greater than one second;
multiplying the target injection rate by the time of the calculation period to determine an amount of reagent to be injected during the calculation period;
setting an injection duty cycle;
determining an injection duration to inject the determined amount of reagent based on the injection duty cycle; and
injecting reagent at the duty cycle for the injection duration.

10. The method of claim 9, wherein the target reagent injection rate is based on an injector delivery parameter.

11. The method of claim 10, wherein the injector delivery parameter includes a flow rate deliverable by the injector.

12. The method of claim 9, wherein the calculation period is ten seconds.

13. The method of claim 12, wherein the injection duty cycle is set to five percent.

14. The method of claim 9, wherein the target reagent injection rate includes units of reagent mass per second.

15. A method of injecting a reagent into a stream of exhaust output from an engine to change the composition of the exhaust, the method comprising:
obtaining a target reagent injection rate;
setting a calculation period to a time greater than one second;
multiplying the target injection rate by the time of the calculation period to determine an amount of reagent to be injected during the calculation period;
setting an injection duration equal to the calculation period;
determining an injection duty cycle to inject the determined amount of reagent in equal increments over the duration; and
injecting reagent at the duty cycle for the injection duration.

16. The method of claim 15, wherein the calculation period is ten seconds.

17. The method of claim 16, wherein the injection duty cycle is set to five percent.

18. The method of claim 15, wherein the target reagent injection rate is based on an injector delivery parameter.

19. The method of claim 18, wherein the injector delivery parameter includes a flow rate deliverable by the injector.

20. The method of claim 15, wherein the target reagent injection rate includes units of reagent mass per second.
